(19) United States
(12) Patent Application Publication
(10) Pub. No.: US 2012/0169027 A1
(43) Pub. Date: Jul. 5, 2012

(54) FOLDABLE BICYCLE HAVING A STABILIZATION SYSTEM

(75) Inventors: Benjamin POULLET, Cysoing (FR); Pierre-Louis BASSETTI, Merignies (FR); Tony MARAIS, Lille (FR)

(73) Assignee: DECATHLON, VILLENEUVE D'ASCQ (FR)

(21) Appl. No.: 13/339,641

(22) Filed: Dec. 29, 2011

(30) Foreign Application Priority Data
Dec. 31, 2010 (FR) 10 61396

(51) Int. Cl. B62K 3/02

(52) U.S. Cl. 280/278

(57) ABSTRACT

The invention relates to a foldable bicycle including a frame that comprises a rear portion on which a rear wheel is arranged, a front portion, and a folding system configured to fold back said front portion against said rear portion. On either side of the bicycle, the rear portion has a tubular structure comprising at least one tube extending longitudinally and having a rear segment and a front segment, assembly means being arranged between said rear segments and the rear wheel, said front segments having a curved shape configured to come into contact with the ground or floor when the front portion is folded back against the rear portion, so that said two front segments and at least the rear wheel stabilize the rear portion of the bicycle in the folded position.

### CROSS REFERENCE TO RELATED APPLICATIONS

This application claims priority to French application No. 10-61396, filed Dec. 31, 2010, which is incorporated herein by reference.

### FIELD OF THE INVENTION

The present invention relates to a foldable bicycle and its main object is to stabilize said bicycle when in its folded position.

### BACKGROUND OF THE INVENTION

In known manner, a foldable bicycle includes a frame made up, in particular, of a rear portion and of a front portion. The rear portion generally includes a rear wheel, a saddle tube, a saddle slidably mounted on the saddle tube via a saddle post, a crankset drive ring, and a transmission system, in particular of the chain type, arranged between said rear wheel and said crankset drive ring. Similarly, the front portion generally comprises a steering tube pivotally receiving a fork having a handlebar arranged at its top end, and having the front wheel arranged at its bottom end. The bicycle further comprises a folding system that is arranged between the rear portion and the front portion so as to enable said front portion to be folded back against said rear portion.

A main drawback suffered by foldable bicycles relates to stabilization of the bicycle when it is in its folded position. Certain foldable bicycles, such as those described in published European Patent No. EP 1 970 296 B1 and in published U.S. Pat. No. US 6,336,649 B1, have a kickstand at the front end of their rear portion. When the front portion is folded back against the rear portion, the combination of the kickstand, of the rear wheel, and of the front wheel makes it possible to constitute three-point contact with the ground or floor, namely two rear points of contact obtained by the front and rear wheels folded back against each other, and a front point of contact obtained by the kickstand. This makes it possible to stabilize the bicycle in the folded position and to hold it more or less suitably in the vertical position.

### SUMMARY OF THE INVENTION

An object of the present invention is to implement a stabilization system for stabilizing the foldable bicycle when it is in its folded position that, in comparison to the foldable bicycles described in Documents EP 1 970 296 B1 and U.S. Pat. No. 6,336,649 B1, is of design that facilitates manufacture of said bicycle and fitting of said stabilization system.

To this end, the invention provides a foldable bicycle including a frame that comprises:

a rear portion on which, in particular, a rear wheel, a saddle tube, a saddle, and a crankset drive ring are arranged;

a front portion on which, in particular, a steering tube, a handlebar, and a front wheel are arranged; and

a folding system arranged between the rear portion and the front portion and configured to fold back said front portion against said rear portion.

In remarkable manner, in the foldable bicycle of the present invention, on either side of the bicycle, the rear portion has a tubular structure comprising at least one tube extending longitudinally and having a rear segment and a front segment, assembly means being arranged between said rear segments of the tubes disposed on either side of the bicycle and the rear wheel. In addition, the front segments of said tubes disposed on either side of the bicycle have a curved shape configured to come into contact with the ground or floor on which said bicycle is placed in the folded position, when the front portion is folded back against the rear portion, so that said two front segments and at least the rear wheel that is standing on the ground or floor stabilize the bicycle in the folded position more or less vertically.

It can be understood that with the design of the bicycle of the present invention, it is no longer necessary to provide a kickstand, unlike in Documents EP 1 970 296 B1 and U.S. Pat. No. 6,336,649 B1. In addition, since the kickstand is omitted, it is no longer necessary to retract it unlike on the bicycles described in Documents EP 1 970 296 B1 and U.S. Pat. No. 6,336,649 B1.

With the invention, folding back the front portion against the rear portion makes it possible systematically to constitute stabilization, through the shape of the front segments of the tubes that make it possible to constitute two front points of contact with the ground or floor when the rear portion of the bicycle in the folded position is inclined downwards by being pivoted about the axis of the rear wheel, said rear wheel itself forming a rear point of contact with the ground or floor.

In addition, the characteristics of the foldable bicycle of the invention as mentioned above offer the advantages of improving the stabilization of the bicycle in its folded position at the front end of the rear portion of the bicycle, the saddle tube and the saddle being positioned in a zone situated above said front end. This offers the advantage of enabling the user to sit on the saddle of the bicycle in the folded and stable position, in particular when the user is traveling with the bicycle in the folded position on public transport such as on a bus or on a train, and when all of the passenger seats are occupied, or indeed when the user of the bicycle wishes to stay close to said bicycle.

In the foldable bicycle of the present invention, the front segment of the tubular structure situated on that side of the bicycle on which the crankset drive ring is situated has a curved shape configured to wrap around said crankset drive ring. This offers the advantage of protecting the crankset drive ring when the bicycle is stabilized in the folded position. This also offers the advantage of protecting the legs of the user of the bicycle while said user is pedaling. This also offers the advantage, in the folded position, of protecting the user and the surrounding environment that can come into contact with the bike.

The foldable bicycle of the present invention includes a transmission system that meshes with the crankset drive ring and with the rear wheel. In addition, the tubular structure disposed on the same side as the crankset drive ring comprises an upper tube and a lower tube connected together at their front ends via a cylindrical tubular segment, the upper and lower tubes and the cylindrical tubular segment wrapping around the transmission system and being of width greater than the width of said transmission system, so as to cover said transmission system and so as to facilitate assembly of the transmission system. This offers the advantage of protecting said transmission system both when the bicycle is in the normal in-use position and when it is in its folded position. In addition, assembly of the transmission system is facilitated since, in conventional constructions, the transmission system and the frame cross over each other, requiring the frame to be open during assembly or a chain in two portions that are assembled together after it has been crossed over with the frame.

In this design of the foldable bicycle of the invention, the transmission system is preferably offset towards the inside of the bicycle relative to the upper and lower tubes and to the cylindrical tubular segment, so as to avoid any contact with said transmission system. This, for example, prevents users from catching their trouser legs in said transmission system while they are pedaling. This also offers the advantage, in the folded position, of protecting the user and the surrounding environment that can come into contact with the bike.

In the foldable bicycle of the invention, the front portion of the tube of the tubular structure that is situated on the side of the bicycle that is opposite from the side on which the crankset drive ring is arranged has a curved shape that is configured to enable said bicycle to be handled using one hand when it is in the folded position. Thus, in addition to the function of stabilizing the bicycle in the folded position, the front segment of the tube also provides a handling function, it being possible, for example, for the user to lift the front end of the rear portion of the bicycle while keeping the rear wheel in contact with the ground or floor, thereby making it easy to move said bicycle in the folded position, or indeed making it very easy to lift the bike without the rear wheel being in contact with the ground or floor.

In the foldable bicycle of the invention, the tubular structures disposed on either side of the bicycle and therefore on either side of the saddle tube and are fastened together, in their front segments, via a first cross-plate, disposed at the bottom. In this design of the bicycle, the saddle tube includes a bottom end that is fastened to the first cross-plate.

In the folding bicycle of the invention, the crankset drive ring is mounted on the saddle tube in a segment situated between the upper tube and the lower tube, on the side on which said crankset drive ring is arranged. This mounting of the crankset drive ring on the saddle tube is achieved independently of said upper and lower tubes and of the cylindrical tubular segment.

In the foldable bicycle of the invention, the front segments of the tubular structures are fastened together via a second cross-plate, disposed at the top, the folding system being arranged on said second cross-plate. In addition, in this design, the second cross-plate is fastened to the saddle tube so as to reinforce the rigidity of the frame of the bicycle.

In the foldable bicycle of the invention, each of the front segments of the tubular structures is provided with a protective piece configured to come into contact with the ground or floor and to protect said front segments, when said foldable bicycle is in the position in which it is folded and stabilized on the ground or floor.

According to the invention, the tubular structures are made of tubes as such that are hollow and circular. However, it is possible to replace such tubes with solid bars of circular, square, rectangular, or some other cross-section. It is also possible to replace them with hollow rods of rectangular, triangular, or some other cross-section. The use of tubes offers the advantage of lightening the frame of the bicycle.

### BRIEF DESCRIPTION OF THE DRAWINGS

The characteristics of the present invention appear on reading the following description of a preferred design embodiment of the foldable bicycle, given with reference to the figures, in which:

FIG. 1 is an overall view of the bicycle ready for use;

FIG. 2 is a fragmentary view of the bicycle in the folded position as stabilized on the ground or floor;

FIG. 3 shows the bicycle in the folded position as stabilized on the ground or floor with a user sitting on the saddle;

FIG. 4 is a fragmentary view of the bicycle in the folded position as being handled by a user;

FIG. 5 shows a preferred design embodiment of the tubular structures disposed on the sides of the foldable bicycle of the invention; and

FIGS. 6 and 7 show two variant designs for the tubular structures.

### DETAILED DESCRIPTION

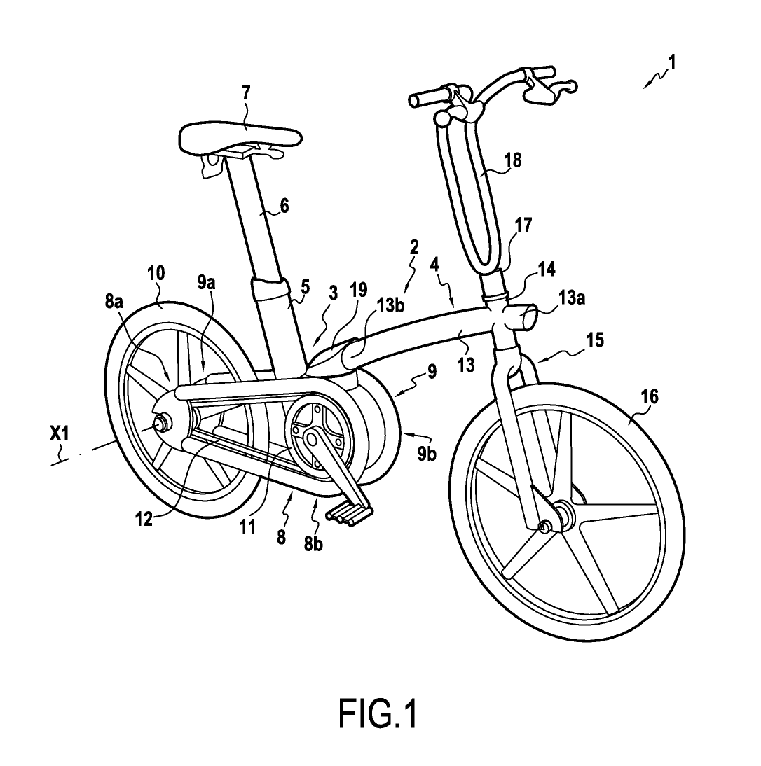

As shown in FIG. 1, the foldable bicycle 1 includes a frame 2 that is made up of a rear portion 3 and of a front portion 4. The rear portion 3 includes a saddle tube 5 that extends more or less vertically, as shown in FIG. 1. This saddle tube 5 slidably receives a saddle post 6, clamping means being implemented for clamping together the saddle post 6 and the saddle tube 5 so as to lock these two elements relative to each other at a desired setting. At its top end, this saddle post 6 receives a saddle 7. In addition, the rear portion 3 includes two tubular structures 8, 9 disposed on either side of the saddle tube 5, as shown in FIG. 1, i.e. on either side of the bicycle.

The bicycle includes a rear wheel 10 that is mounted on the bicycle to pivot about a transverse axis X1 . The rear wheel is assembled in this way relative to the rear segments 8a, 9a of the two tubular structures 8, 9. In FIG. 1, it can also be seen that the rear portion 3 receives a crankset drive ring 11 and a transmission system 12 that may consist of a chain or of a belt, this transmission system 12 being arranged between the crankset drive ring 11 and the rear wheel 10.

The front portion 4 of the bicycle 1 includes a longitudinal tube 13 at the front end 13a of which a steering tube 14 is arranged that extends substantially vertically, with a slight rearward inclination, as shown in FIG. 1. Said directional tube 14 receives a fork 15 in a manner such that it is mounted to pivot about the longitudinal axis of said steering tube 14. At the bottom end of the fork 15, a front wheel 16 is mounted to pivot about an axis that is transverse to said fork 15. At its top end, said fork 15 receives a stem 17 on which a handlebar 18 is mounted.

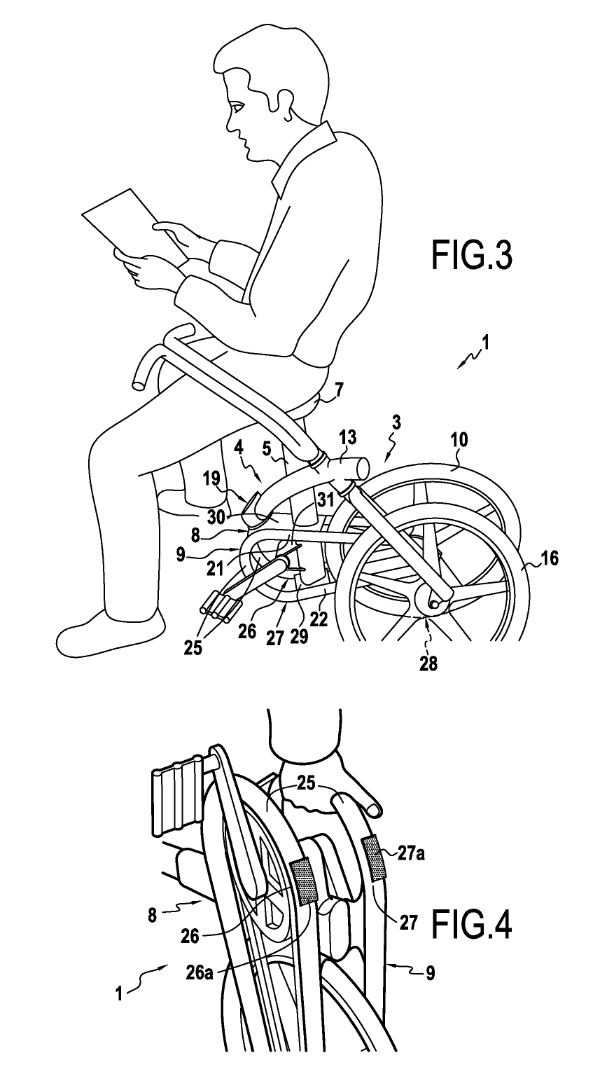

It can be seen, in particular from FIGS. 1 to 3, that a folding system 19 is arranged between the rear end 13b of the longitudinal tube 13 and the front segments 8b, 9b of the two tubular structures 8, 9. This folding system 19 makes it possible to fold back the front portion 4 against the rear portion 3, as shown in FIG. 3. When the bicycle 1 is in this folded position, the axis of the front wheel 16 is disposed substantially in alignment with the axis of the rear wheel 10, as shown in FIG. 3. Depending on the design of this folding system 19, it is possible to make provision for the front wheel 16 to be offset slightly upwards relative to the rear wheel 10, when the bicycle is folded.

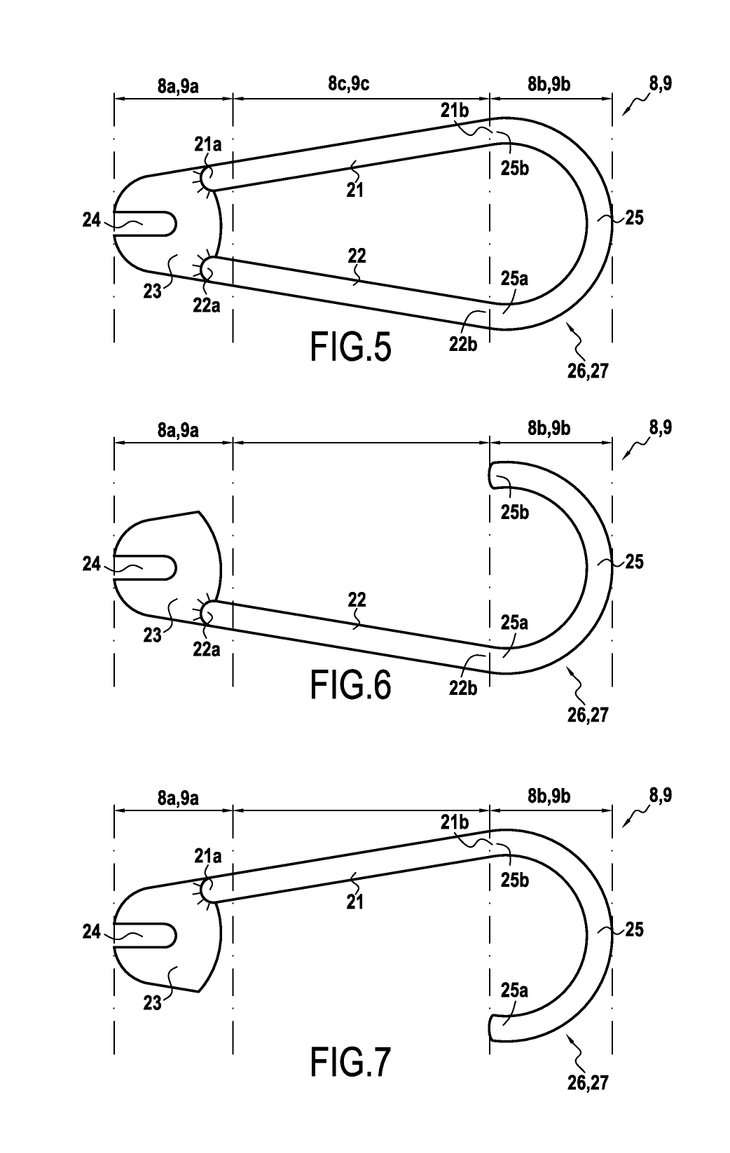

FIG. 5 shows, in detail, a preferred design for the tubular structures 8, 9 implemented on either side of the bicycle 1. In its central segment 8c, 9c, each of these tubular structures 8, 9 comprises an upper tube 21 and a lower tube 22. It can be seen in FIG. 5 that, in the rear segment 8a, 9a of each of said tubular structures 8, 9, the rear ends 21a, 22a of the upper and lower tubes are fastened to a support plate 23 that is provided with a rearwardly-opening groove 24 that enables a respective end of the spindle of the rear wheel 10 to be fastened, as appears in FIG. 1. It can be seen in FIG. 5 that, at the front segment 8b, 9b of each of the tubular structures 8, 9, the front ends 21b, 22b of the upper tube 21 and of the lower tube 22 are fastened to a cylindrical tubular segment 25. The upper tube 21, the cylindrical tubular segment 25, and the lower tube 22 may be implemented by means of distinct tubular elements that are fastened together, in particular by welding. It is, however, possible to implement said upper tube 21, said tubular segment 25, and said lower tube 22 by means of a single tube that is curved back on itself

It can be seen, in particular in FIG. 1, that the tubular structure 8 on the side of the bicycle on which the crankset drive ring 11 is situated wraps around said crankset drive ring 11 and the transmission system 12. Preferably, the tubular structure 9 on the side that is opposite from the side on which the crankset drive ring 11 is situated is of shape and dimensions that are identical to the shape and dimensions of the first tubular structure 8.

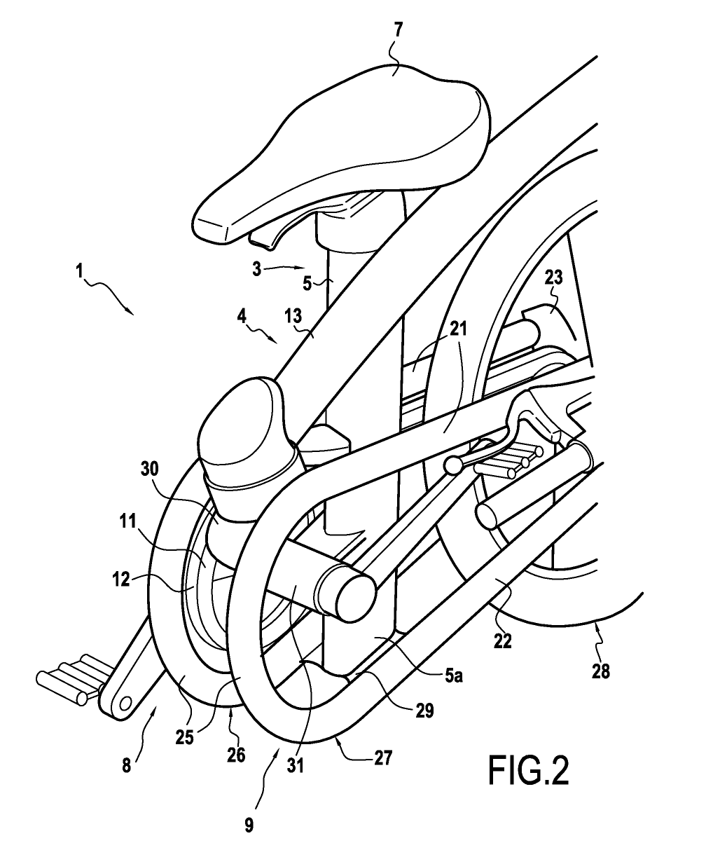

Said cylindrical tubular segments 25 at the front segments 8b, 9b of the tubular structures 8, 9 make it possible to constitute two points of contact 26, 27 that, as shown in FIGS. 2 and 3, enable contact to be made with the ground or floor or the surface on which the bicycle 1 in the folded position is standing, and enable the rear portion 3 of the bicycle 1 to be held in a vertical position. Thus, in the folded position, the bicycle is stabilized by a combination of the two points of contact 26, 27 of the two cylindrical tubular portions 25 disposed on the sides of the bicycle and by at least the point of contact 28 of the bottom portion of the rear wheel 10 that is also in contact with the ground or floor. These two points of contact 26, 27 make it possible to stabilize suitably the front end of the rear portion 3 of the bicycle 1, at the top of which end the saddle tube 5 is disposed. This makes is possible for the user to sit on the saddle in stable manner, as is shown in FIG. 3.

It can be seen in FIG. 4 that, at the points of contact 26, 27 of each of the cylindrical tubular portions 25, the tubular structures 8, 9 are provided with protective pieces 26a, 27a configured to stand on the ground or floor so as to avoid damaging the tubular structures 8, 9 when the bicycle in the folded position is standing on the ground or floor.

It can be seen in FIGS. 2 to 4 that a first plate 29 is fastened, in particular by welding, between the bottom ends 25a of the cylindrical tubular segments 25 of the two tubular structures 8, 9, these bottom ends 25a of the cylindrical tubular segments 25 adjacent to the front ends 22b of the lower tubes 22. It can be seen in FIGS. 2 and 3 that the bottom end 5a of the saddle tube 5 is fastened to this first cross-plate 29 disposed at the bottom.

Similarly, it can be seen in FIGS. 2 and 3 that a second cross-plate 30, disposed at the top is fastened, in particular by welding, between the top ends 25b of the cylindrical tubular segments 25 of the two tubular structures 8, 9. The top ends 25b are adjacent to the front ends 21b of the upper tubes 21. It can be seen in FIGS. 2 and 3 that this second cross-plate 30, disposed at the top, receives the folding system 19 and is fastened, in particular by welding, to the saddle tube 5, more or less in the central portion of said saddle tube 5. Naturally, it is possible to make provision for the first and second cross-plates 29, 30 to be fastened at the front ends 21b, 22b of the upper and lower tubes 21, 22, when the tubular structures 8, 9 are as shown in FIG. 5.

It can be seen in FIGS. 2 and 3 that the bottom bracket 31 of the crankset drive ring 11 is fastened to the saddle tube 5, said bottom bracket 31 being disposed between the upper tube 21 and the lower tube 22 of the two tubular structures 8, 9, or indeed at the bottom of the cylindrical tubular segment 25.

The tubular structure 8 disposed on the side on which the crankset drive ring 11 is situated is dimensioned so that the width of the upper and lower tubes 21, 22 and of the cylindrical tubular segment 25 is greater than the width of the transmission system 12 constituted, for example, by a transmission belt or by a transmission chain. In addition, as can be seen in particular in FIG. 1, said transmission system 12 is offset slightly towards the inside of the bicycle 1 relative to the tubular structure 8. This offers the advantage of avoiding any contact with the transmission system 12, in particular via the user's leg, while the bicycle 1 is being used.

It can be seen in FIG. 4 that the cylindrical tubular segment 25 of the tubular structure 9 that is disposed on the side of the bicycle that is opposite from the side on which the crankset drive ring 11 is situated, makes it possible, by means of its curved shape, for the bicycle to be handled when said bicycle is in the folded position.

Other characteristics may be implemented without going beyond the ambit of the present invention. In particular, it is possible to provide variant designs for the tubular structures 8 and 9 that are preferably identical for reasons of appearance, but that can be of different design, these various designs having, however, a curved portion making it possible to constitute the two points of contact 26, 27 coming into contact with the ground or floor when the bicycle is in the folded position, so as to stabilize the bicycle 1. In particular, it is possible to provide variant designs as shown in FIGS. 6 and 7. It can be seen in FIG. 6 that the tubular structure 8, 9 is of design similar to the design described above with reference to FIG. 5, but with the upper tube 21 having been omitted from the design. Conversely, in FIG. 7, it can be seen that the tubular structure 8, 9 has a design similar to the design of FIG. 5 that is described above, but with the lower tube 22 having been omitted. In both cases, it can be seen that the cylindrical tubular segment 25 has a point of contact 26, 27 coming into contact with the ground or floor when the bicycle is in the folded position as stabilized on the ground or floor, as shown in FIGS. 2 and 3.

In the above description, reference is made to tubular structures. The use of a tube makes it possible to lighten the frame of the bicycle. However, it is possible, without going beyond the ambit of the present invention, to implement the frame by using solid bars, or indeed hollow rods, of cross-section of shape other than the shape of a circle, e.g. a square, a rectangle, or a triangle, depending on the appearance that is desired for the bicycle.

When the bicycle 1 is in the folded position, the axis of the front wheel 16 is disposed either in alignment with the axis of the rear wheel 10, or slightly offset upwards relative to the axis of the rear wheel 10, depending on the design of the folding system 19. Such folding systems 19 are known to the person skilled in the art. It can be understood that when the axis of the front wheel 16 is disposed in alignment with the axis of the rear wheel 10, the front and rear wheels 16, 10 stand on the ground or floor and, in combination with the two points of contact 26, 27 of the cylindrical tubular segments 25 of the two tubular structures 8, 9, stabilize the bicycle in the folded position. Conversely, when the axis of the front wheel 16 is offset upwards relative to the axis of the rear wheel 10, only the rear wheel provides a point of contact with the ground or floor and stabilizes the bicycle in the folded position in combination with the two points of contact 26, 27 of the cylindrical tubular segments 25 of the two tubular structures 8, 9.

1. A foldable bicycle including a frame that comprises:
a rear portion on which, in particular, a rear wheel, a saddle tube, a saddle, and a crankset drive ring are arranged;
a front portion on which, in particular, a steering tube, a handlebar, and a front wheel are arranged; and
a folding system arranged between the rear portion and the front portion and configured to fold back said front portion against said rear portion;
wherein, on either side of the bicycle, the rear portion has a tubular structure comprising at least one tube extending longitudinally and having a rear segment and a front segment, assembly means being arranged between said rear segments and the rear wheel, said front segments having a curved shape configured to come into contact with the ground or floor when the front portion is folded back against the rear portion, so that said two front segments and at least the rear wheel stabilize the rear portion of the bicycle in the folded position.

2. A foldable bicycle according to claim 1, wherein the front segment of the tubular structure situated on that side of the bicycle on which the crankset drive ring is situated has a curved shape configured to wrap around said crankset drive ring.

3. A foldable bicycle according to claim 2, including a transmission system that meshes with the crankset drive ring and with the rear wheel, the tubular structure on the same side as the crankset drive ring comprising an upper tube and a lower tube connected together at the front via a cylindrical tubular segment, said upper and lower tubes and said cylindrical tubular segment wrapping around the transmission system and being of width greater than the width of said transmission system, so as to cover said transmission system and so as to facilitate assembly of the transmission system.

4. A foldable bicycle according to claim 3, wherein the transmission system is offset towards the inside of the bicycle relative to the upper and lower tubes and to the cylindrical tubular segment, so as to avoid any contact with said transmission system.

5. A bicycle according to claim 1, wherein the front portion of the tube of the tubular structure that is situated on the side of the bicycle that is opposite from the side on which the crankset drive ring is arranged has a curved shape that is configured to enable said bicycle to be handled using one hand when it is in the folded position.

6. A foldable bicycle according to claim 1, wherein the tubular structures are disposed on either side of the saddle tube and are fastened together, in their front segments, via a first cross-plate.

7. A foldable bicycle according to claim 6, the saddle tube including a bottom end that is fastened to the first cross-plate.

8. A foldable bicycle according to claim 3, the crankset drive ring being mounted on the saddle tube in a segment situated between the upper tube and the lower tube, independently of said upper and lower tubes.

9. A foldable bicycle according to claim 1, the front segments of the tubular structures being fastened together via a second cross-plate, the folding system being arranged on the second cross-plate.

10. A foldable bicycle according to claim 9, the second cross-plate being fastened to the saddle tube.

11. A foldable bicycle according to claim 1, each of the front segments of the tubular structures being provided with a protective piece configured to come into contact with the ground or floor and to protect said front segments.
